(19) United States
(12) Patent Application Publication
(10) Pub. No.: US 2006/0203423 A1
(43) Pub. Date: Sep. 14, 2006

(54) Multi-layer ceramic capacitor and production method thereof

(76) Inventors: Kwi-Jong Lee, Seoul (KR); Byung-Ho Jun, Seoul (KR)

Correspondence Address: STANZIONE & KIM, LLP, 919 18TH STREET, N.W., SUITE 440, WASHINGTON, DC, 20006, US

(21) Appl. No.: 11/330,070

(22) Filed: Jan. 12, 2006

(30) Foreign Application Priority Data
Mar. 11, 2005 (KR) 2005-20603

(51) Int. Cl. H01G 4/008

(52) U.S. Cl. 361/305

(57) ABSTRACT

The present invention relates to a multi-layer ceramic capacitor comprising internal electrode formed with a metal which has a melting temperature simultaneously sinterable with a dielectric material, dielectric, and external electrode and a method for preparing the same. According to the present invention, the multi-layer ceramic capacitor comprises a plurality of dielectric sheets; a plurality of internal electrodes of which material is a metal having a melting temperature simultaneously sinterable with the dielectric and formed between the dielectric layers to lead each one end to be exposed to one end surface of the dielectric layer; and external electrode electrically connecting with the end of the exposed internal electrode so that it allows to have a thin thickness and to sinter the internal electrode and the dielectric at the same time.

### CROSS-REFERENCE TO RELATED APPLICATIONS

This application claims the benefit of Korean Patent Application No. 2005-20603 filed with the Korea Industrial Property Office on Mar. 11, 2005, the disclosure of which is incorporated herein by reference.

### BACKGROUND OF THE INVENTION

1. Field of the Invention

The present invention relates to an electronic component and more particularly, a multi-layer ceramic capacitor and a method for manufacturing the same.

2. Description of the Related Art

Multi-layer ceramic capacitor (MLCC: Multi-Layer Ceramic Capacitor) is an electronic component of laminated capacitors with a number of layers and performs various functions such as blockage of DC signals, bypassing, resonant frequency, and the like. Needs for smaller and lightweight multi-layer ceramic capacitor are increasing with the development of handheld communication terminals. According to the conventional technology, a multi-layer ceramic capacitor has been prepared by printing an electrode paste on a green sheet, cutting after layering a plurality of the green sheets, firing at a high temperature, coating an external electrode, firing, and coating.

Generally, requirements for archiving large capacitance of multi-layer ceramic capacitor's include increasing area of the internal electrode, using dielectrics having a higher dielectric constant, thinning of the dielectric layers, increasing number of stacked layers, and the like. Here, the thickness of the internal electrode is thinnered to increase number of stacked layers. However, when a particle size of metal power of the internal electrode becomes small, it is known that a melting temperature gets lowered, resulting in lowering a sintering temperature and causing electrode short or crack since shrinkage of the internal electrode and shrinkage of dielectric material become different each other during the sintering process.

FIG. 1a illustrates cracks of the internal electrode produced during the sintering process according to the conventional technology and FIG. 1b illustrates difference in shrinkage of the internal electrode and the dielectric during the sintering process according to the conventional technology.

Referring FIG. 1a, when a melting temperature is lowered due to use of fine particles of metal power of the internal electrode, it causes higher shrinkage of the internal electrode than that of the dielectric, which results in cracks. Further, referring FIG. 1b, when a melting temperature is lowered due to use of fine particles of metal power of the internal electrode, it causes difference in shrinkage rate of the internal electrode and the dielectric with temperature during the sintering process which may further cause twist or cracks of the multi-layer ceramic capacitor's shape.

Thus, when particle size of the used metal power of the internal electrode is small, it is not possible to sinter the dielectric and the internal electrode material at the same time.

### SUMMARY OF THE INVENTION

An object of the present invention is to provide a multi-layer ceramic capacitor comprising internal electrode which has no cracks during sintering even with fine particle powders and a preparing method thereof.

Additional aspects and advantages of the present general inventive concept will be set forth in part in the description which follows and, in part, will be obvious from the description, or may be learned by practice of the general inventive concept.

Further, another object of the present invention is to provide a multi-layer ceramic capacitor which allows to sinter both the internal electrode and the dielectric material at the same time and has a thin thickness and a preparing method thereof.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1a illustrates cracks of the internal electrode produced during the sintering process according to the conventional technology.

FIG. 1b illustrates difference in shrinkage of the internal electrode and the dielectric during the sintering process according to the conventional technology.

FIG. 2 illustrates a multi-layer ceramic capacitor according to a preferred embodiment of the Invention.

FIG. 3 illustrates a relationship between an average particle size and melting temperature according to a preferred embodiment of the Invention.

FIG. 4 is a flow chart illustrating a process for preparing multi-layer ceramic capacitor according to a preferred embodiment of the Invention.

FIG. 5 illustrates a relationship between sintering temperature and volume according to a preferred embodiment of the Invention.

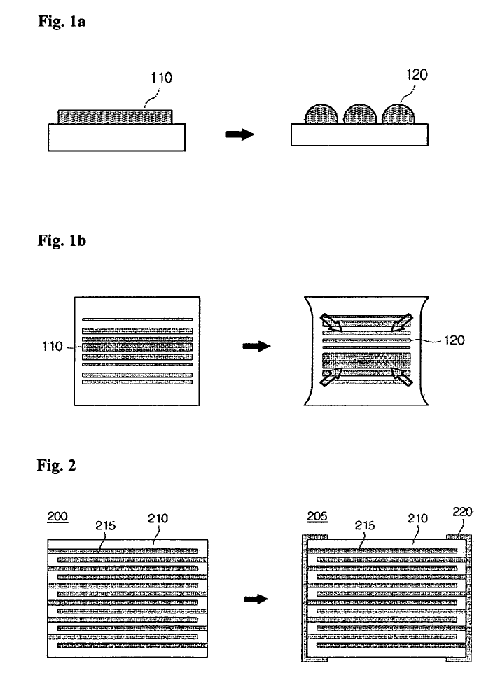

110: internal electrode before sintering
120: internal electrode after sintering
210: dielectric
215: internal electrode
220: external electrode

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

According to one aspect of the present invention, a multi-layer ceramic capacitor comprises internal electrodes, dielectric materials, and external electrodes, wherein the internal electrode is formed from a metal powder having a particle of nanosize and a melting temperature simultaneously sinterable with the dielectric.

According to another aspect of the present invention, it is provided a multi-layer ceramic capacitor.

According to a preferred embodiment of the present invention, the multi-layer ceramic capacitor comprises a plurality of dielectric sheets, a plurality of internal electrodes of which material is a metal having a melting temperature simultaneously sinterable with the dielectric and which are formed between the dielectric layers to lead each one end to be exposed to one end surface of the dielectric layer, and external electrodes which are electrically connected with one end of the exposed internal electrode.

According to another aspect of the present invention, it is provided a method for preparing the multi-layer ceramic capacitor.

According to a preferred embodiment of the present invention, a method for preparing the multi-layer ceramic capacitor comprises forming dielectric sheets with dielectric powder, forming internal electrodes with metal powder having a particle of nanosize and a melting temperature simultaneously sinterable with the dielectric, and sintering the dielectric powder and the metal powder at the same time.

Here, the metal powder is tungsten(W) or molybdenum(Mo) and an average particle size of tungsten or molybdenum is in the range of 1 to 100 nm.

The dielectric BaTiO3(Barium Titanate, BT) or its derivatives which are partial substituted BT having an average particle size of 50 to 200 nm. And the internal electrode is formed by one chosen from inkjet method, gravure printing and screen print method.

Hereinafter, the present invention will be described with preferred embodiments shown in accompanying drawings. In description, reference number indicating the same component will be used as same regardless of the number of drawing. Before describing the preferred embodiments of the present invention in detail, multi-layer ceramic capacitor is described.

FIG. 2 illustrates the multi-layer ceramic capacitor according to a preferred embodiment of the present invention of which one comprises dielectrics 210 and internal electrodes 215 and the other comprises dielectrics 210, internal electrodes 215, and external electrodes 220.

The dielectric 210 is an exterior body of the multi-layer ceramic capacitor of which material is ceramic so that it is also called a ceramic body. Typical dielectric 210 is BaTiO3(Barium Titanate, BT) which is high dielectric at an atmospheric temperature. BT powder of the dielectric 210 has about 1250° C. of a sintering temperature.

The internal electrode 215 has conductivity and is positioned within the dielectric 210. Examples of the internal electrode's material include palladium(Pd), and nickel(Ni), copper(Cu) of which melting temperature are 1555° C., 1452° C., 1083° C., respectively.

The external electrode 220 has conductivity to connect the multi-layer ceramic capacitor with an external power. The multi-layer ceramic capacitor is an element to be the external power but also provides a good adhesiveness with the solder.

Capacitance of the multi-layer ceramic capacitor is expressed by the following equation:

$$C = ɛ \frac{A}{d} ( n - 1 ) \qquad ( 1 )$$

wherein, C is capacitance, ε is dielectric constant of the dielectric, d is thickness of the dielectric, A is area of the internal electrode, n is number of layers.

According to the equation 1, dielectrics having a higher dielectric constant may be used, the dielectric layers may be thinnered, or area of the internal electrode may be increased in order to archive large capacitance of the multi-layer ceramic capacitor's. Thus, since it is required to form thin layers as thin as possible to obtain a multi-layer ceramic capacitor having super capacity, capacitance of the multi-layer ceramic capacitor can be increased when both dielectric layers and internal electrodes are formed thinly. Thereby, both metal powder used for the internal electrode and dielectric powder should have small particle size to form both thin dielectric layers and thin internal electrodes. According to conventional technologies, a particle size of BT as the dielectric powder is about 100 nm and that of Ni powder as the metal powder is 200 nm since if it is too small, it is easily oxidized.

When the size of the metal powder is reduced, thickness and surface roughness of the internal electrode are decreased but it lowers a melting temperature.

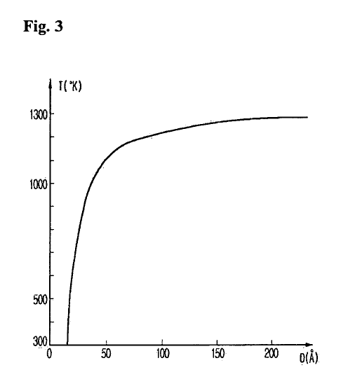

FIG. 3 illustrates a relationship between a melting temperature and average particle size according to a preferred embodiment of the present invention. Referring FIG. 3, it illustrates a relationship between a melting temperature and average particle size of gold(Au).

Ph. Buffat and J-P. Borel suggested the following equation for the melting temperature drop by metal particle size variation in Physical Review A, 13 (1976), 2290,

$$1 - θ = \frac{2}{{ρ}_{s} {Lr}_{s}} [ {γ}_{s} - {{γ}_{l} ( \frac{{ρ}_{s}}{{ρ}_{l}} )}^{\frac{2}{3}} ] \\ θ = {T}_{m} / {T}_{0} \qquad ( 2 )$$

wherein ρs is solid density [kg/m3], ρl is liquid density [kg/m3], L is latent heat [J/kg], rs is particle size [m], γs is surface tension in solid [J/m2], and γs is surface tension in liquid [J/m2].

According to the equation 2, the melting temperature decreases with decrease to nanosize in the particle size. Thus, when the particle size of metal used in the internal electrode decreases, its sintering temperature also decreases which can be different from that of the dielectric. As a result, when both metal powder and dielectric powder are sintered, they shrink at different temperature, resulting in cracks or short of the internal electrode as described above.

In order to resolve such problems are there two methods one of which is to lower the sintering temperature of the dielectric powder and the other is to raise the sintering temperature of the metal powder used in the internal electrode. The method to raise the sintering temperature of the metal powder of the internal electrode is provided in the present invention. That is, a metal having a high melting temperature is used for the internal electrode to be able to sinter the dielectric powder along with the metal powder.

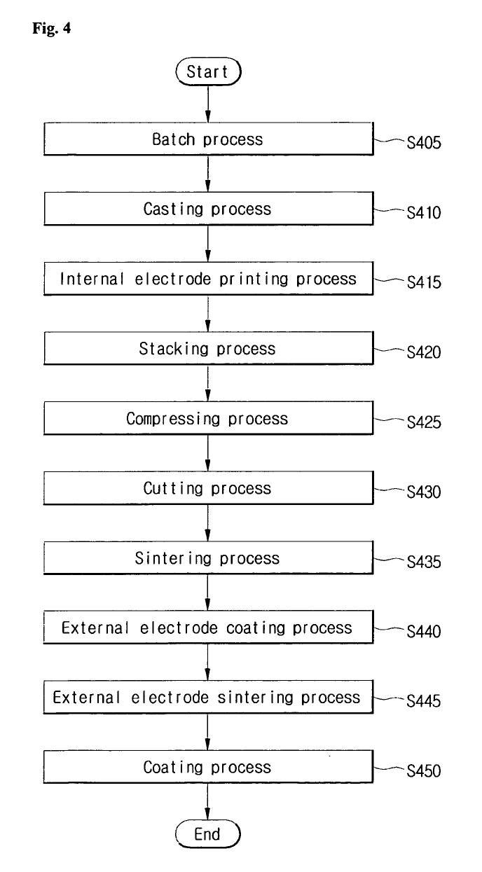

FIG. 4 is a flow chart illustrating a method for preparing the multi-layer ceramic capacitor according to a preferred embodiment of the present invention.

At step 405, the dielectric powder is dispersed into a solution including dispersant and binder to obtain slurry and at step 410 the slurry is molded to film by employing a carrier film.

At step 415, the internal electrode having a high melting temperature is printed on the molded dielectric film. Here, the internal electrode can be printed by various method including screen printing, gravure method, inkjet method and the like. When ink is used for the internal electrode, the ink for the internal electrode comprises binder and solvent.

At step 420, the dielectric film printed with the internal electrode is then laminated into a desired number of layers and at step 425, the layers are pressed. At step 430, it is cut into a chip unit and at step 435 the dielectric powder and the metal powder used in the internal electrode are sintered. At 440, the external electrode is coated to be connected electrically to the internal electrode and at step 445, the external electrode is sintered.

Here, before sintering the metal powder for the internal electrode, the external electrode is coated to sinter the dielectric powder along with the metal powder. At step 450, the multi-layer ceramic capacitor is prepared with a chip unit via the coating process.

When the internal electrode is formed with a metal having a melting temperature

When the internal electrode is formed with a metal having a melting temperature simultaneously sinterable the dielectric, the multi-layer ceramic capacitor may be prepared by employing any method, not only by the method of the preferred embodiment of the present invention. For example, after the dielectric and the internal electrode are sintered, the dielectric film printed with the internal electrode can be cut with a predetermined pattern.

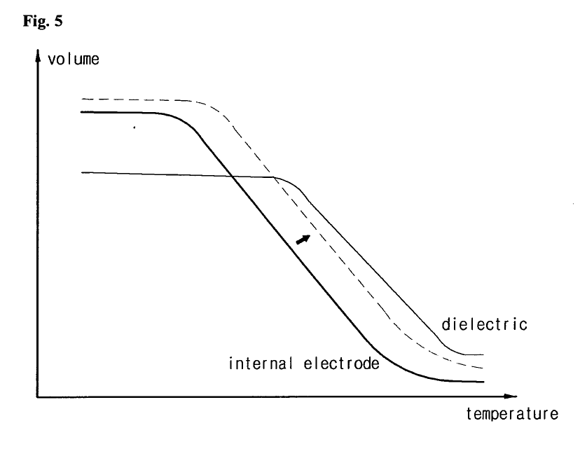

FIG. 5 illustrates a relationship between volume and temperature during sintering according to a preferred embodiment of the present invention. Referring to FIG. 5, when the temperature increases during sintering, the total volume decreases. Here, the sintering temperature of the internal electrode is lower than that of the dielectric so that when metal powder having a high melting temperature is used for the internal electrode, the metal can be sintered along with the dielectric to show the same relationship between volume and temperature of the internal electrode as that of the dielectric.

Examples of the metal having a high melting temperature include molybdenum and tungsten of which have melting temperature of 2622° C. and 3387° C., respectively. When molybdenum or tungsten is used for the internal electrode, any general method can be applied. For example, the metal can be molded by a powder metallurgical process. Here, molybdenum and tungsten powder has a size of 1 to 100 nm and BT powder has a size of 50 to 200 nm

The dielectric sheet may be molded by employing a die coater or a gravure coater. Molybdenum or tungsten may be used without coating or be coated on the surface to lead the same sintering temperature with the dielectric and further, when molybdenum or tungsten is dispersed into a solution including dispersant, small amount of a polymer can be added to enhance adhesiveness with the dielectric. Various printing method can be applied according to the thickness of the internal electrode. For example, when the thickness of the internal electrode is thicker than 1 mm, the screen printing is applied and when it is less than 1 mm, the gravure or inkjet method is applied. Here, detailed description of the printing method is omitted since it is well known to those in the art.

In addition, Molybdenum or tungsten has more than 30% lower resistivity than nickel(Ni) conventionally used for the internal electrode so that the multi-layer ceramic capacitor using multi-layer ceramic capacitor exhibits superior high frequency characteristics.

Conventional drying process such as sputtering, chemical vapor deposition(CVD), or vacuum deposition allows patterning on the film but it is costly due to use of vacuum equipment, has poor productivity, requires an additional mask, and is not allowed to have patterns at present invention provides excellent productivity at low cost and the inkjet or gravure printing also provides excellent productivity and allows thin film printing. Further, the gravure printing has 100 times faster of manufacturing process compared to the screen printing and inkjet printing does not require for plate(mask) manufacturing cost and exhibits improved productivity.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

### EFFECTIVENESS OF THE INVENTION

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A multi-layer ceramic capacitor comprising internal electrode, dielectric, and external electrode, wherein the internal electrode is formed with metal powder having a particle of nanosize and a melting temperature simultaneously sinterable with the dielectric.

2. The multi-layer ceramic capacitor of claim 1, wherein said metal is tungsten(W) or molybdenum(Mo).

3. The multi-layer ceramic capacitor of claim 2, wherein an average particle size of said tungsten(W) or molybdenum(Mo) is in the range of 1 to 100 nm.

4. The multi-layer ceramic capacitor of claim 1, wherein said dielectric is BaTiO₃ having an average particle size of 50 to 200 nm.

5. The multi-layer ceramic capacitor of claim 1, wherein said internal electrode is formed by one selected from the group consisting of inkjet printing, gravure printing, and screen printing.

6. A multi-layer ceramic capacitor comprising:
a plurality of dielectric sheets;
a plurality of internal electrodes which is a metal having a melting temperature simultaneously sinterable with the dielectric at a nanosize and formed between the dielectric layers so that one end of each internal electrode is exposed to one side of the dielectric layer; and
an external electrode electrically connecting the one end of the exposed internal electrode.

7. The multi-layer ceramic capacitor of claim 6, wherein said metal is tungsten(W) or molybdenum(Mo).

8. The multi-layer ceramic capacitor of claim 7, wherein an average particle size of said tungsten(W) or molybdenum(Mo) is in the range of 1 to 100 nm.

9. The multi-layer ceramic capacitor of claim 6, wherein said dielectric is BaTiO₃ having an average particle size of 50 to 200 nm.

10. The multi-layer ceramic capacitor of claim 6, wherein said internal electrode is formed by one selected from the group consisting of inkjet printing, gravure printing, and screen printing.

11. A method for preparing multi-layer ceramic capacitor comprising:
forming dielectric sheets with dielectric power;
forming internal electrodes with metal power having a particle of nanosize and a melting temperature simultaneously sinterable with the dielectric on the dielectric sheet; and
sintering the dielectric power and the metal power at the same time.

12. The method for preparing multi-layer ceramic capacitor of claim 11, wherein said metal is tungsten(W) or molybdenum(Mo).

13. The method for preparing multi-layer ceramic capacitor of claim 12, wherein an average particle size of said tungsten(W) or molybdenum(Mo) is in the range of 1 to 100 nm.

14. The method for preparing multi-layer ceramic capacitor of claim 11, wherein said dielectric is BaTiO₃ having an average particle size of 50 to 200 nm.

15. The method for preparing multi-layer ceramic capacitor of claim 11, wherein said internal electrode is formed by one selected from the group consisting of inkjet printing, gravure printing, and screen printing.
